(19) United States
(12) Patent Application Publication
(10) Pub. No.: US 2010/0025498 A1
(43) Pub. Date: Feb. 4, 2010

(54) Tap device for connection to a sprinkler system

(76) Inventor: David L. Cole, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/220,953

(22) Filed: Jul. 29, 2008

(51) Int. Cl. B05B 1/32

(52) U.S. Cl. 239/538

(57) ABSTRACT

A sprinkler tap connects to a fitting of an in-ground sprinkler system and includes an elongate tubular body having a fluid flow passage extending between an open bottom end and a first output port at a top end. A second output port communicates with the fluid flow passage between the bottom end and the first output port. The first output port is adapted for receiving either a male or female sprinkler head or, alternatively, a plug. A quick connect fitting on the second output port allows for easy connection and disconnection of a hose. The opposite end of the hose may be attached to a portable sprinkler device, a hand held spray nozzle or other water dispensing device. The quick connect fitting has an internal stop valve that closes when the hose is disconnected from the device, thereby preventing wasteful discharge of water from the second output port.

### BACKGROUND OF THE INVENTION

1. Field of the Invention

The invention relates to a device for tapping a sprinkler system and, more particularly, to a sprinkler tap for connection to an in-ground sprinkler system to allow for temporary connection of a garden hose fitted to a portable sprinkler, spray nozzle or other device.

2. Discussion of the Related Art

Automatic sprinkler systems for irrigating lawns and shrubs are well known and typically comprise a main diverter valve connected to both a water supply source and an arrangement of underground PVC pipes that lead to one or more zones. Each zone is fitted with a number of sprinkler heads that are strategically positioned throughout the zone in an effort to provide water to an entire area of grass and/or plants, trees and shrubs within the zone. The sprinkler heads are fitted to either in-ground fittings that pop up and spray water in a desired pattern when the zone is pressurized, or on the top end of a riser pipe for spraying water over the tops of plants and shrubs. An automatic timer control operates the main diverter valve and is set to sequentially activate each zone during a timed cycle of operation.

While automatic sprinkler systems are highly effective for maintaining proper irrigation of lawns and shrubs without excess waste of water, it is not uncommon to encounter insufficient watering in one or more areas of a zone. If this is a permanent, on-going problem, the best solution may be to either add more sprinkler heads to the zone or move existing heads so that all areas are properly irrigated. However, adding and/or moving sprinkler heads is labor intensive and may require installation of additional underground pipes to reach the desired areas. This can be a relatively expensive job which usually requires hiring a professional sprinkler installation service.

Often, the need to provide additional watering to particular areas in a sprinkler zone is temporary and, accordingly, the labor and cost of extending underground piping is not justified. For instance, newly planted grass or flowers may required heavier watering than normal until the roots extend and take hold in the soil. Also, during a drought, when the number of watering days may be restricted, certain areas of a lawn or garden may not receive adequate water from the permanent sprinkler heads. This is particularly a problem in areas that encounter little to no shade during the summer months.

Presently, supplemental watering of these temporary trouble areas is accomplished by attaching a garden hose to a hose bib (i.e., a spigot) and a portable sprinkler device that is placed at the desired area. This approach requires the water to be turned on and off manually at the hose bib. Moreover, the connection point for the hose is not always conveniently located, thereby requiring multiple lengths to be connected in order to reach the desired area. The need to manually operate the water spigot tends to waste considerable amounts of water, as the sprinkler is often left running longer than necessary. Additionally, the unsightly appearance of a garden hose extending across lawns, patios and driveways, as well as the need to mow the lawn, requires frequent removal and replacement of the extended length of garden hose and the portable sprinkler device.

Accordingly, there remains a need for a simple and easy to install tap device that attaches to an underground sprinkler system to allow for temporary connection and select placement of a portable sprinkler or other device to effectively irrigate areas of a lawn, garden or shrubs that require additional watering. More particularly, there remains a need for a sprinkler tap device that utilizes the timed zone control activation features of an existing underground sprinkler system to allow for additional irrigation of particular areas of a lawn or garden without the need for manual activation, thereby preventing excess waste of water and eliminating the inconvenience of extended lengths of garden hose.

### SUMMARY OF THE INVENTION

The present invention is directed to a sprinkler tap device that connects to a fitting of the underground piping of an automatic sprinkler system. The sprinkler tap device includes an elongate tubular body with a fluid flow passage extending between an open bottom end and a first output port at a top end of the tubular body. A second output port extending from the elongate tubular body communicates with the fluid flow passage between the bottom end and the first output port at the top end. The first output port is adapted for receiving either a male or female sprinkler head. Alternatively, the first output port can be capped off with a plug fitting.

The second output port is structured for attachment of a fluid conduit, such as a flexible garden hose. In a preferred embodiment, the second output port is provided with a quick connect fitting that has a female receptacle and an internal stop valve. A corresponding male component attaches to the end of the garden hose and is adapted for water tight connection within the female receptacle of the quick connect fitting. The opposite end of the garden hose may be attached to a portable sprinkler device, a hand held spray nozzle or other water dispensing device. When the male component on the end of the garden hose is disconnected from the quick connect fitting, the internal stop valve operates to a normally closed position, thereby preventing wasteful discharge of water from the second output port when the particular zone of the sprinkler system is activated.

The sprinkler tap device of the present invention can be easily installed to an existing automatic sprinkler system by first removing a sprinkler head fixture at the desired location within any zone of the system. The sprinkler tap device can then be attached to the threaded fitting of the pipe system from which the sprinkler head fixture was removed. Moreover, the sprinkler tap device can be easily moved from one location to another in any zone of the automatic sprinkler system.

### BRIEF DESCRIPTION OF THE DRAWINGS

For a fuller understanding of the nature of the present invention, reference should be made to the following detailed description taken in conjunction with the accompanying drawings in which:

FIG. 1 is an exploded elevational view illustrating the sprinkler tap of the present invention for connection to an underground irrigation system and showing alternative attachment of either a male or female threaded sprinkler head to a first output port on a top end and connection of a garden hose to a quick connect fitting at a second output port of the device;

FIG. 2 is an elevational view showing the sprinkler tap of the present invention connected to an underground irrigation system with both a sprinkler head on the device activated and the quick connect fitting of the device connected to a garden hose and portable sprinkler;

FIG. 3 is an elevational view showing the sprinkler tap of the present invention connected to an underground irrigation system with a sprinkler head on the device activated and the garden hose disconnected from the quick connect fitting, thereby closing a stop valve feature in the quick connect fitting; and

FIG. 4 is an isolated elevational view showing an arrangement of fittings on a top end of the device for receiving a plug to close a first discharge port on the top of the device.

Like reference numerals refer to like parts throughout the several views of the drawings.

### DETAILED DESCRIPTION OF THE PREFERRED EMBODIMENT

The sprinkler tap device of the present invention is shown throughout the several views of the drawings and is generally indicated as 10.

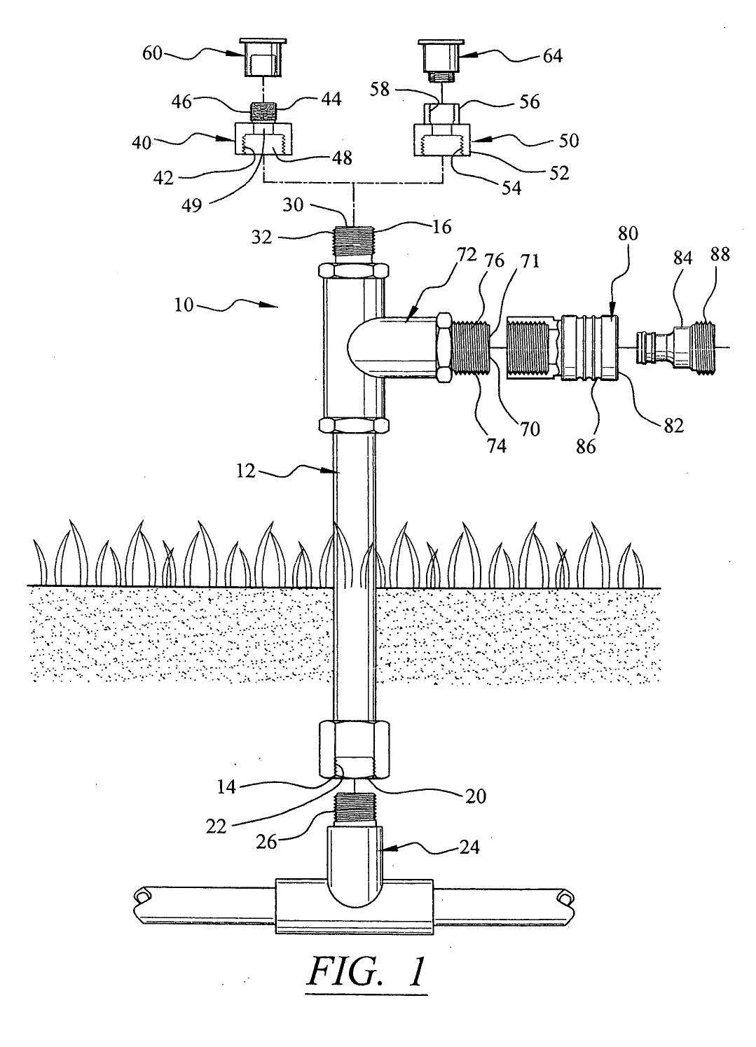

Referring initially to FIG. 1, the sprinkler tap device 10 includes a generally elongate tubular body 12 extending between a bottom end 14 and a top end 16. The bottom end 14 is open and defines an input port 20 for threaded attachment with a fitting 24 of an automatic sprinkler conduit system. Specifically, the input port 20 on the bottom end is provided with threads 22 for threaded engagement with a threaded member 26 on an existing fitting 24 of an automatic sprinkler system. As seen throughout the several views of the drawings, the fitting 24 may be a PVC T-connector in the underground piping of the automatic sprinkler system. In a preferred embodiment, the threads 22 of the input port 20 at the bottom end are interior, thereby defining a female threaded end for attachment to a male (i.e., exterior) threaded member 26 of the fitting 24.

The top end 16 of the device 10 is open to define a first output port 30. Exterior threads 32 on the top end 16 allow for selective attachment of a male adapter 40 or a female adapter 50. The male adapter 40 has interior threads 42 for engagement with the exterior threads 32 of the top end of the device 10. The male adapter 40 further includes an attachment stub 44 with exterior threads 46 for threaded engagement of a female (i.e., internal threads) sprinkler head 60. The male adapter 40 is open at both ends with a fluid flow passage therethrough. The lower portion 48 of the fluid flow passage of the male adapter has a larger diameter, with the upper portion 49 being of reduced diameter to allow for attachment of the female sprinkler head 60.

The female adapter 50 includes a lower portion 52 with internal threads 54 for attachment to the top end 16 of the device 10. An upper portion 56 of the female adapter 50 is of a reduced diameter and includes internal threads 58 for threaded attachment of a male sprinkler head 64.

The sprinkler tap device 10 further includes a second output port 70. As seen throughout the several views of the drawings, a preferred embodiment of the device includes a tubular segment 72 extending from the elongate tubular body 12 of the device 10. In a preferred embodiment, the tubular segment 72 is generally perpendicular to the longitudinal axis of the main tubular body 12. An open end 71 of the tubular segment 72 communicates with the interior fluid flow passage extending between the input port 20 at the bottom end of the device 10 and the first output port 30 at the top end 16 of the device. The open end 71 of the tubular segment 72 defines the second output port 70 for connection of an additional water dispensing device. Specifically, a distal end portion 74 of the tubular segment 72 surrounding the second output port 70 is structured for attachment of a water dispensing device. More particularly, the end of the tubular segment 72 surrounding the second output port 70 is structured for attachment of a garden hose 90 thereto. In one embodiment, the distal end portion 74 of the tubular segment 72 is provided with exterior threads 76 for threaded attachment of either a garden hose coupling 92 or a quick connect fitting 80. In another embodiment, the tubular segment 72 may be manufactured to include an integral quick connect fitting 80.

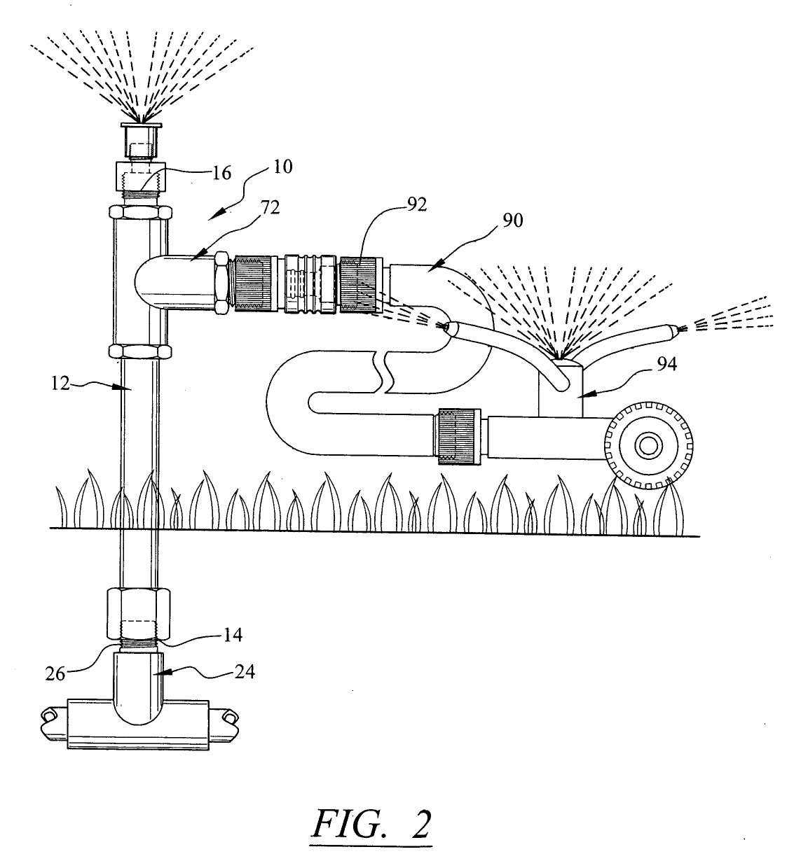

In the preferred embodiment, as shown throughout the several views of the drawings, the quick connect fitting 80 is provided on the end of the tubular segment 72 and further defines the second output port 70 of the device. The quick connect fitting 80 is provided with an internal stop valve that is normally closed to prevent outward flow of water from the second output port. A female receptacle 82 of the quick connect fitting 80 is structured for cooperative, interconnecting receipt of a male component 84. Sliding movement of an exterior collar 86 of the quick connect fitting 80, from a normally relaxed position, allows for insertion and removal of the male component 84 within the female receptacle 82. The male component 84 of the quick connect fitting 80 is provided with threads 88 for attachment to a coupling 92 on the end of a garden hose 90. When the male component 84 is received and interlocked within the female receptacle 82 of the quick connect fitting, the internal stop valve is opened, thereby permitting fluid flow of water from within the device and out through the second output port 70, through the male component 84 and into the attached garden hose 90. The opposite end of the garden hose 90 can be connected to a portable sprinkler device 94, as seen in FIG. 2, or a hand held spray nozzle, as well as any other water dispensing device.

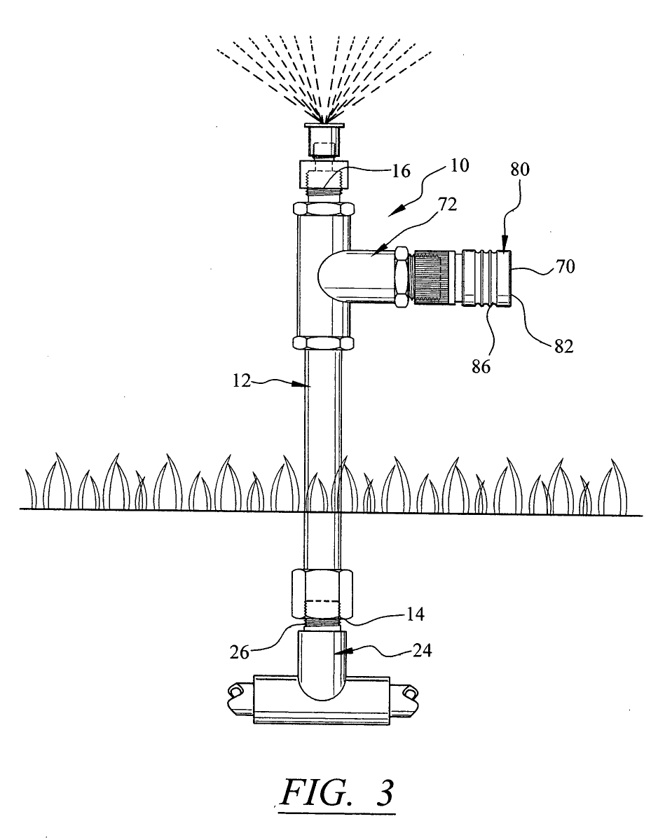

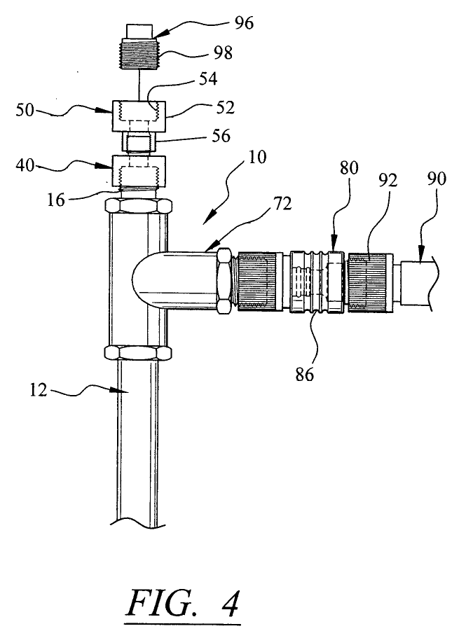

Referring to FIG. 4, the first output port 30 can be capped off with a plug 96. In a preferred embodiment, the plug 96 is attached using both the male adapter 40 and the female adapter 50. As shown in FIG. 4, the internal threads 54 of the upper portion 56 engage with the exterior threads 46 of the male adapter 40. The plug 96 can then be fastened within the lower portion 52 of the female adapter 50 which is now facing upwardly, as seen in FIG. 3. Specifically, exterior threads 98 on the plug 96 engage with the internal threads 54 of the lower portion 52 of the female adapter 50.

In use, the device 10 can be operated to dispense water from both a sprinkler head attached to the first output port 30 as well as a portable sprinkler device 94 attached to the second output port 70, as shown in FIG. 2. When the garden hose 90 is disconnected and the stop valve of the quick connect fitting 80 is closed, dispensing of water is limited to the sprinkler head on the top end of the device (see FIG. 3) during operation of the automatic sprinkler system. Alternatively, the first output port 30 can be capped off, using the plug 96, as seen in FIG. 4. In this instance, when the garden hose 90 is connected to the quick connect fitting 80 of the second output port 70, water is only directed out through the second output port 70 and into the hose and attached water dispensing device (e.g., a portable sprinkler device) during operation of the automatic sprinkler system in the particular zone. If the garden hose is removed from the quick connect fitting 80 and the plug 96 is fastened to cap off the first output port, no water is dispensed from the device during activation of the sprinkler system.

While the present invention has been shown and described in accordance with a preferred and practical embodiment thereof, it is recognized that departures from the instant disclosure are fully contemplated within the spirit and scope of the invention.

What is claimed is:

1. A sprinkler tap device for connection to an automatic sprinkler system, said device comprising:
an elongate tubular body having an open bottom end, an opposite top end with a first output port, and a fluid flow passage extending between said open bottom end and said first output port;
said open bottom end being structured for attachment to the automatic sprinkler system in fluid flow communication therewith, and said open bottom end defining an input port;
a sprinkler head attachment member on said top end;
a second output port disposed in fluid flow communication with said fluid flow passage between said bottom end and said first output port; and
a hose attachment structure surrounding said second output port.

2. The device as recited in claim 1 further comprising:
threads adjacent to said open bottom end for threaded attachment of said device to the automatic sprinkler system.

3. The device as recited in claim 2 wherein said hose attachment structure is a quick connect fitting.

4. The device as recited in claim 3 wherein said quick connect fitting includes a female receptacle surrounding said second output port and a corresponding male component structured for releasable attachment within said female receptacle in fluid flow communication with said fluid flow passage and said second output port, and said male component being structured for removable attachment to an end of a flexible hose, wherein said hose is disposed in fluid flow communication with said fluid flow passage and said second output port when said male component is attached within said female receptacle.

5. The device as recited in claim 4 wherein said sprinkler head attachment member and said top end are correspondingly structured and disposed for threaded attachment of said sprinkler head attachment member to said top end in fluid communication with said first output port.

6. The device as recited in claim 5 wherein said sprinkler head attachment member includes an open top end in fluid communication with said first output port, and said sprinkler head attachment member further includes exterior threads adjacent to said open top end for removable attachment of a female threaded sprinkler head thereto in fluid communication with said open top end.

7. The device as recited in claim 5 wherein said sprinkler head attachment member includes an open top end in fluid communication with said first output port, and said sprinkler head attachment member further includes interior threads adjacent to said open top end for removable attachment of a male threaded sprinkler head thereto in fluid communication with said open top end.

8. A sprinkler tap device for connection to an automatic sprinkler system, said device comprising:
an elongate tubular body having an open bottom end, an opposite top end with a first output port, and a fluid flow passage extending between said open bottom end and said first output port;
said open bottom end being structured for attachment to the automatic sprinkler system in fluid flow communication therewith, and said open bottom end defining an input port;
a sprinkler head attachment member on said top end;
a sprinkler head for attachment to said sprinkler head attachment member in fluid flow communication with said first output port;
a second output port disposed in fluid flow communication with said fluid flow passage between said bottom end and said first output port; and
a hose attachment structure surrounding said second output port for removable attachment of a hose thereto in fluid flow communication with said second output port and said fluid flow passage.

9. The device as recited in claim 8 further comprising:
threads adjacent to said open bottom end for threaded attachment of said device to the automatic sprinkler system.

10. The device as recited in claim 9 wherein said hose attachment structure is a quick connect fitting.

11. The device as recited in claim 10 wherein said quick connect fitting includes a female receptacle surrounding said second output port and a corresponding male component structured for releasable attachment within said female receptacle in fluid flow communication with said fluid flow passage and said second output port, and said male component being structured for removable attachment to an end of a flexible hose, wherein said hose is disposed in fluid flow communication with said fluid flow passage and said second output port when said male component is attached within said female receptacle.

12. The device as recited in claim 11 wherein said sprinkler head attachment member and said top end are correspondingly structured and disposed for threaded attachment of said sprinkler head attachment member to said top end in fluid communication with said first output port.

13. The device as recited in claim 12 wherein said sprinkler head includes interior female threads and said sprinkler head attachment member includes exterior male threads for attached engagement with said interior female threads of said sprinkler head.

14. The device as recited in claim 12 wherein said sprinkler head includes exterior male threads and said sprinkler head attachment member includes interior female threads structured for attached engagement with said exterior male threads of said sprinkler head.

15. The device as recited in claim 12 further comprising:
a plug for removable attachment to said sprinkler head attachment member for closing said first output port and thereby preventing fluid flow out from said first output port.
